(19) United States
(12) Patent Application Publication
(10) Pub. No.: US 2009/0207611 A1
(43) Pub. Date: Aug. 20, 2009

(54) Lighting Device

(76) Inventor: Chanan Gardi, Firenze (IT)

Correspondence Address: THE WEBB LAW FIRM, P.C., 700 KOPPERS BUILDING, 436 SEVENTH AVENUE, PITTSBURGH, PA, 15219, US

(21) Appl. No.: 12/278,461

(22) PCT Filed: Feb. 6, 2007
(86) PCT No.: PCT/IT2007/000077

§ 371 Date: Dec. 11, 2008

(30) Foreign Application Priority Data
Feb. 6, 2006 (IT) BO2006A000066

(51) Int. Cl. F21V 21/00; F21V 19/00; F21V 1/00

(52) U.S. Cl. 362/249.02; 362/382; 362/317

(57) ABSTRACT

A lighting device comprises a support or base having ferromagnetic features; one or more fixing elements reversibly associable to the support by means of magnetic attraction; a structure for supporting and/or shielding one or more luminous source. The structure is stably associable to the support or base by means of the fixing elements, fixed to the support or base according to different configurations.

The present invention relates to a lighting device.

The lighting devices currently in commerce consist of lamps, generally of incandescent or halogen lamps, which have a brightness fixed or variable by means of rheostats or regulators. With such devices usually the appearance of the lamp is not variable, that is it is not possible to vary its configuration, the modalities of the diffusion of the light, the light and shade effects or chiaroscuro that they can supply.

Scope of the present invention is to provide a lighting device that allows to modify own aspect and configuration, so as to supply different luminous effects according to the assumed aspect or configuration.

This result has been achieved according to the invention thanks to the idea of actuating a lighting device having the features described in claim 1. Other features relate to the dependant claims.

Among the advantages of the present invention there are: it is possible to vary the luminous effect given by the device, also with light effects of chiaroscuro that is light and shade based, for example, according to the undulations of the structure of support/shielding of the luminous sources; the device provides an elevated safety during the use, joined to an extreme easiness in the operations relating to the modification of the configuration; the lighting device can assume an elevated number of different conformations allowing, in this way, the use of the same device in various situations of use; the device can supply an appreciable aesthetic effect according to the particular assumed conformation; the device requires a relatively easy mounting/assembly; the device maintains its characteristics unchanged also after extends periods of use.

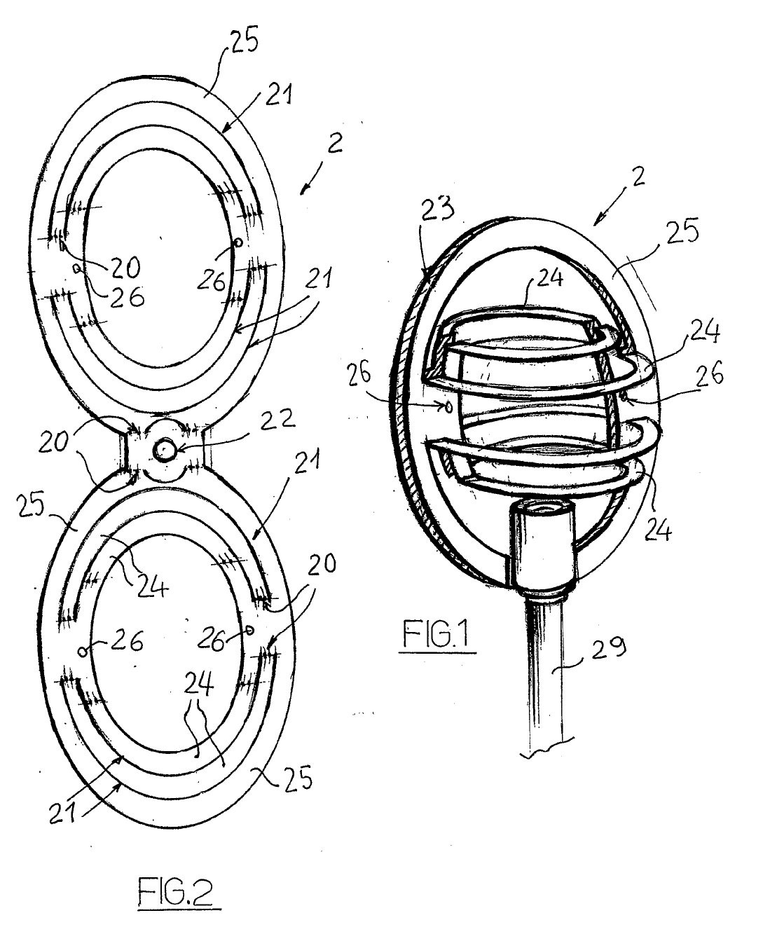

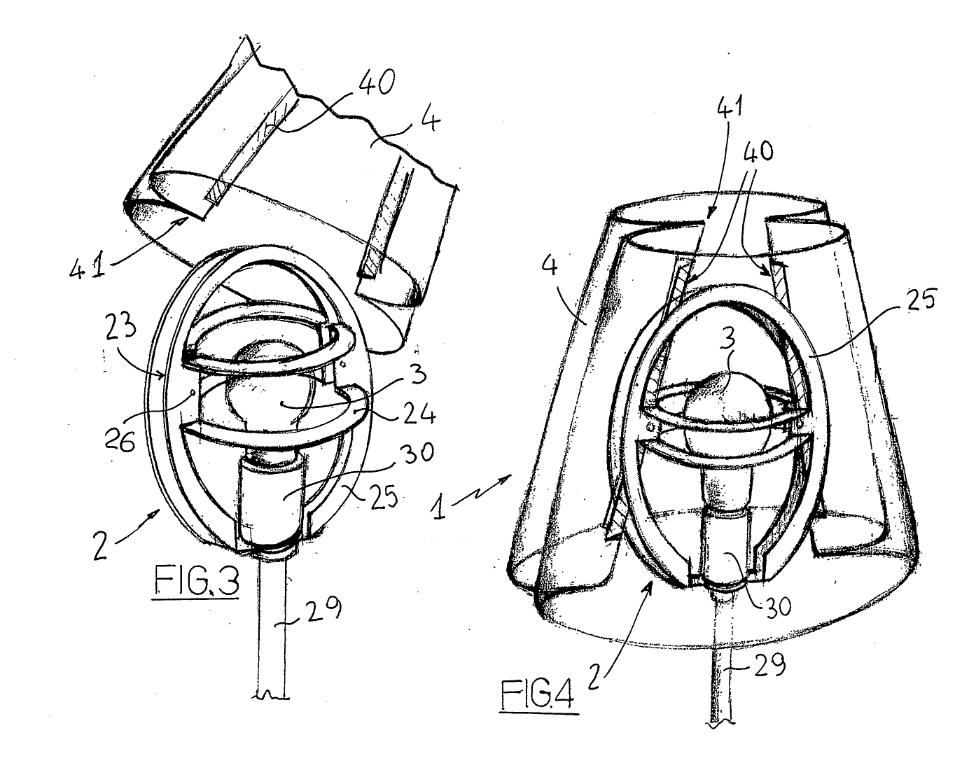

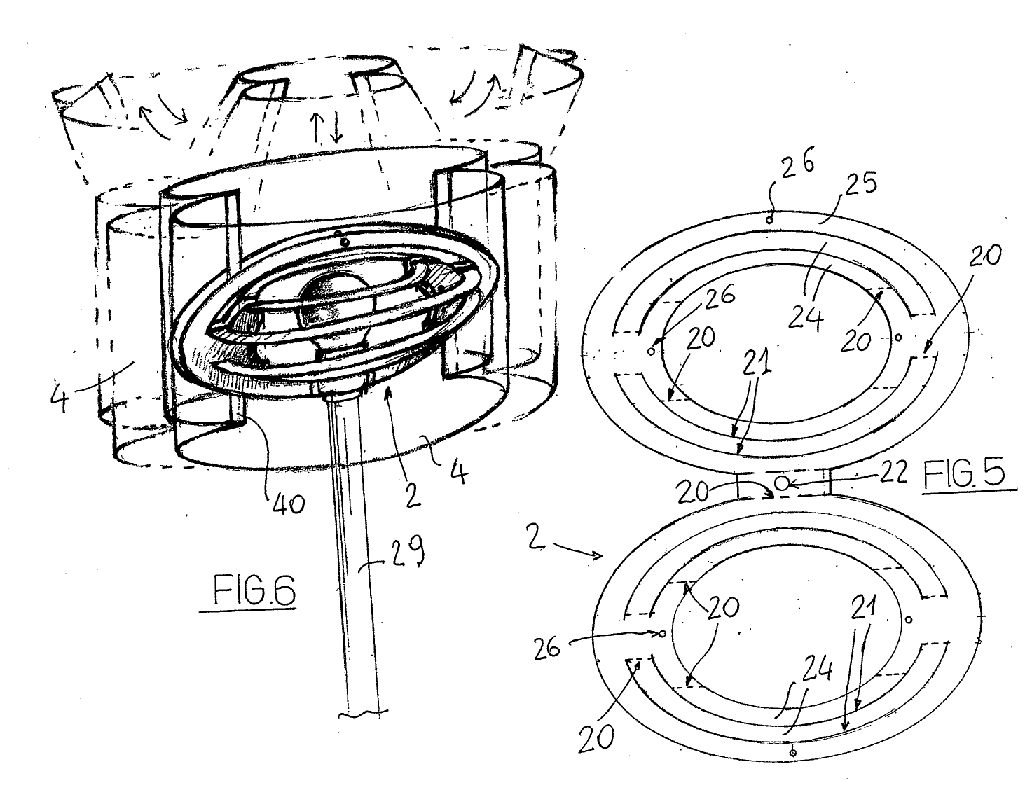

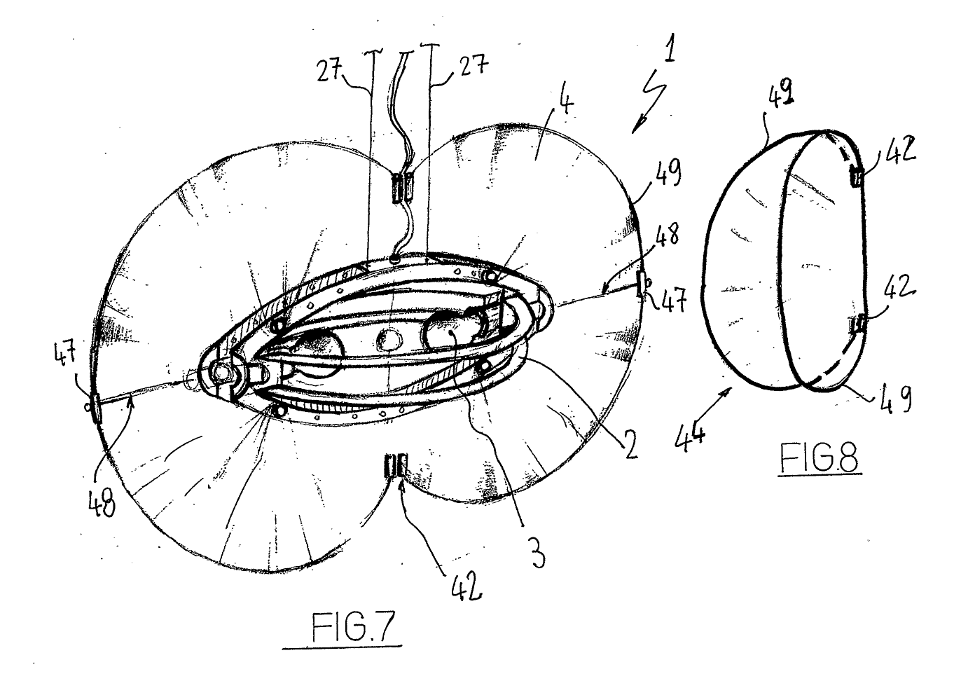

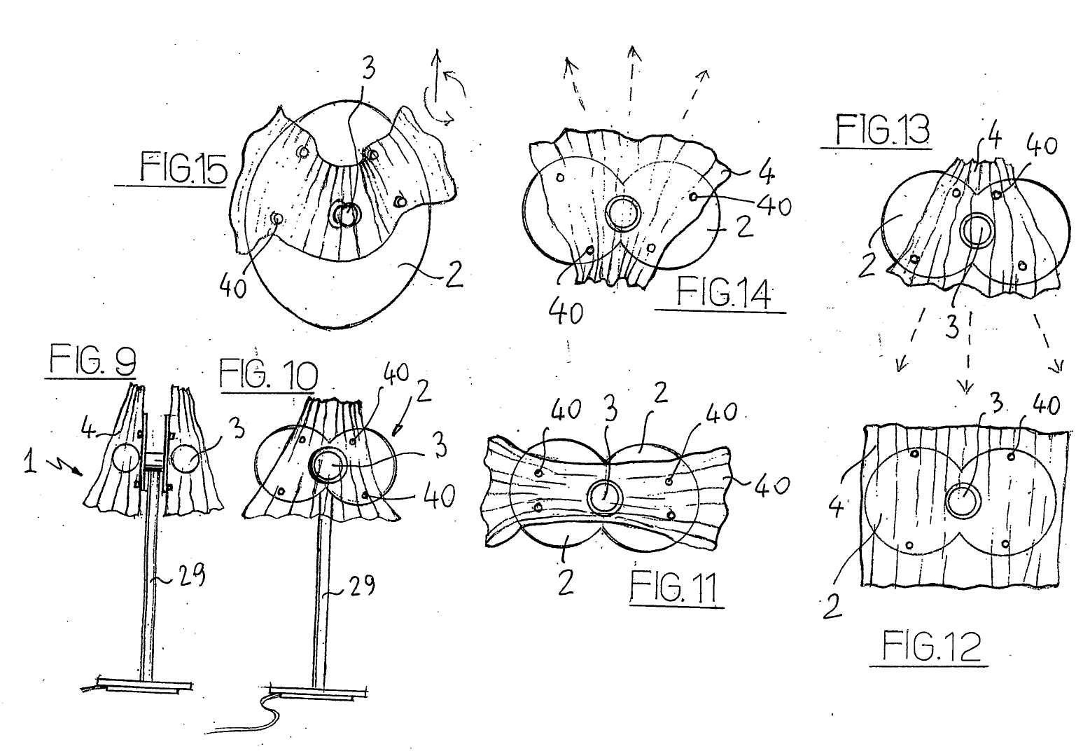

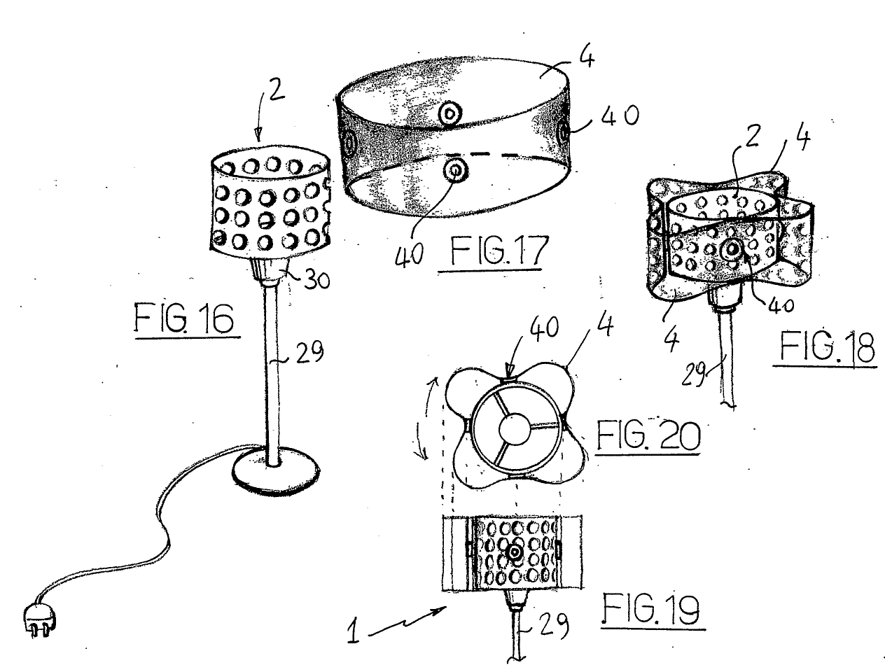

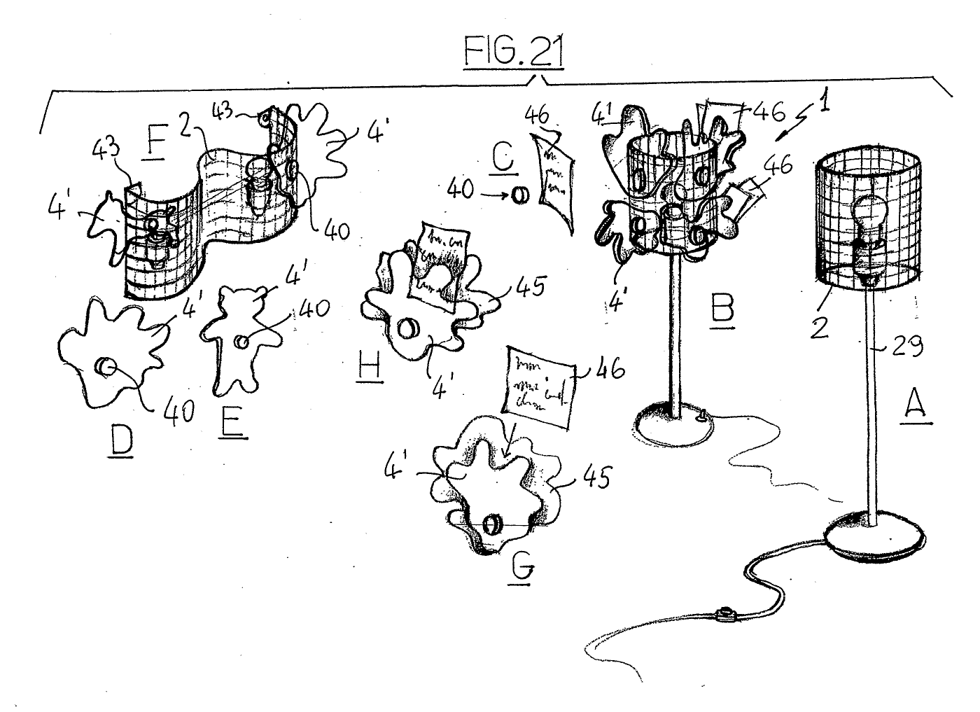

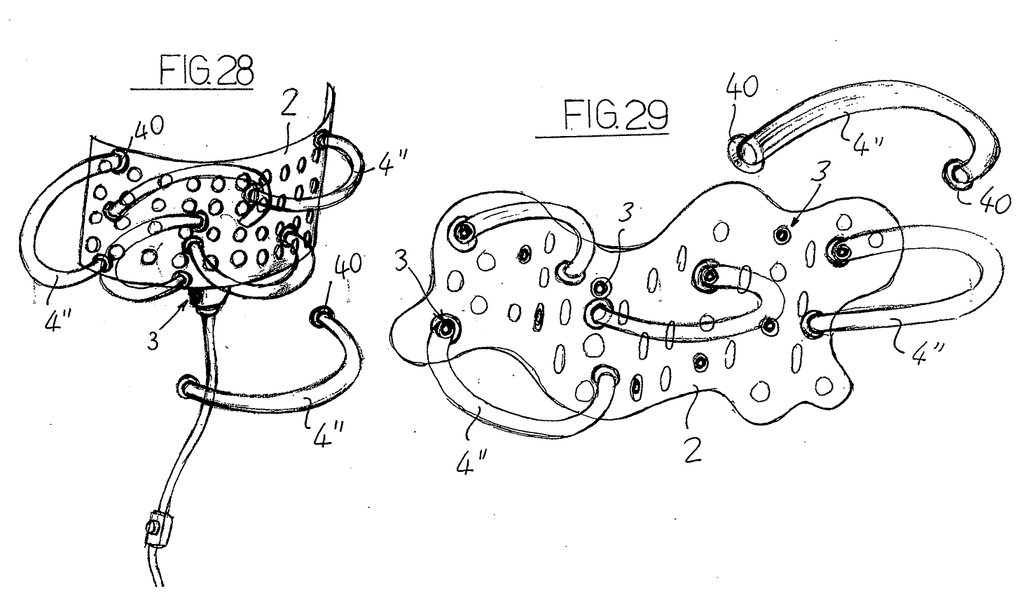

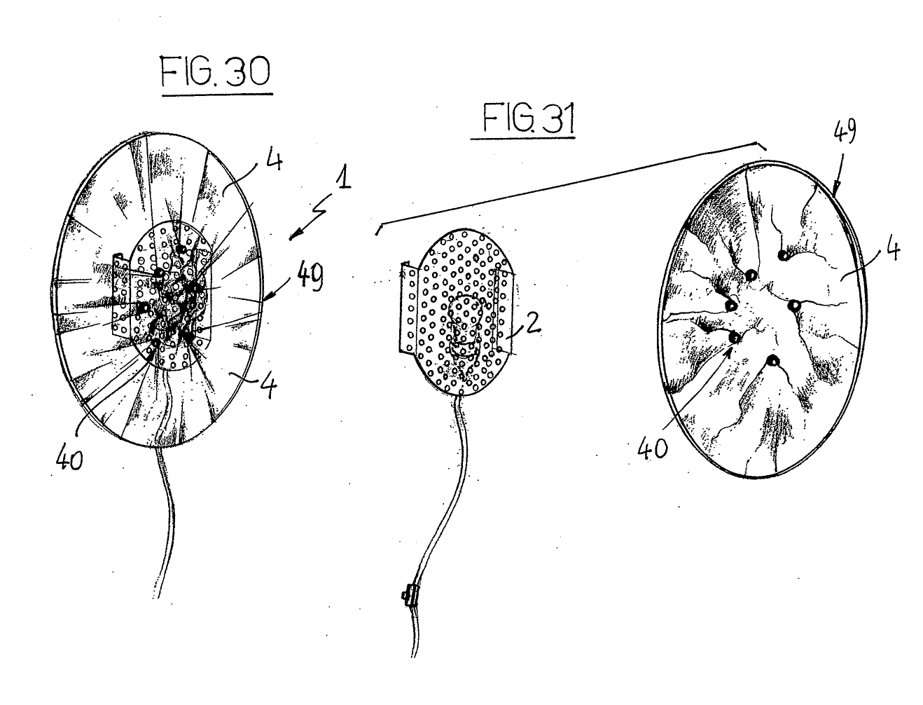

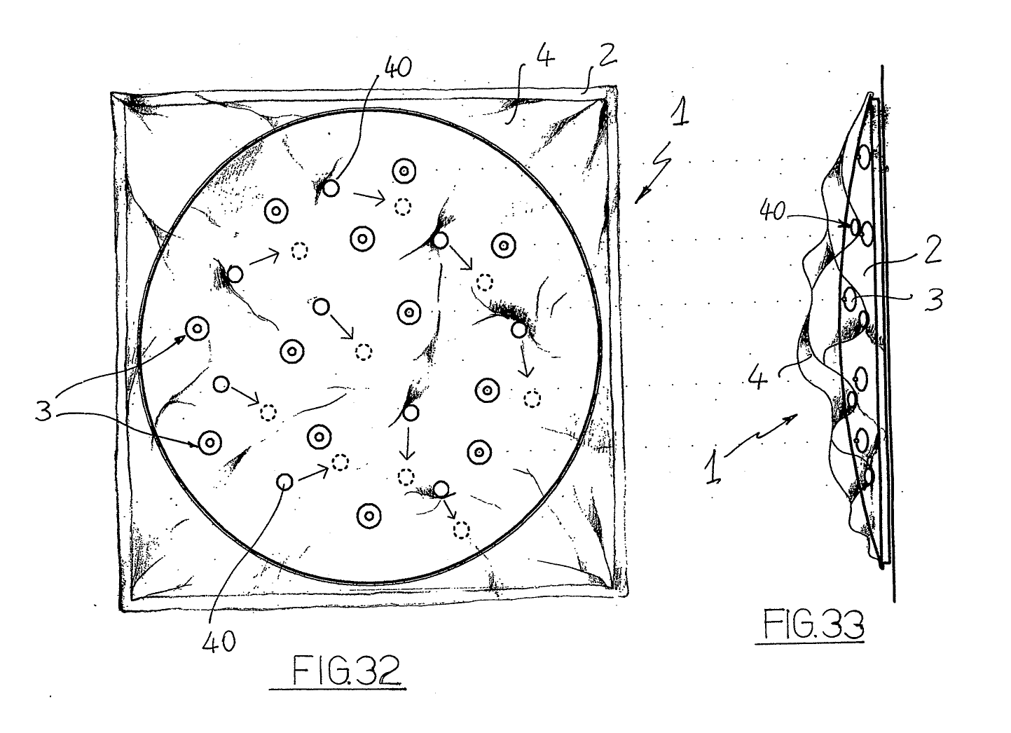

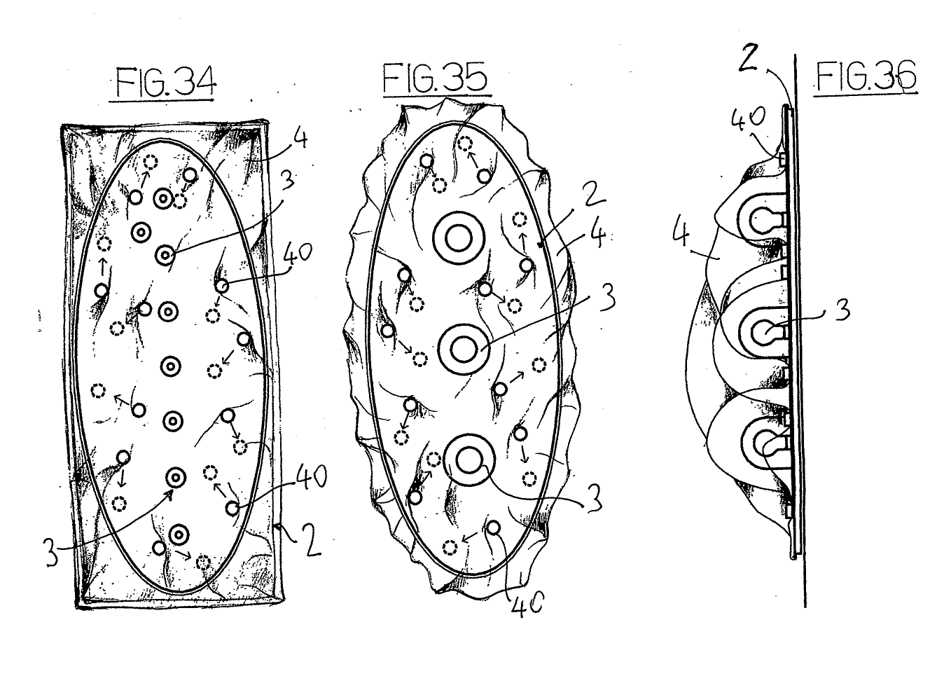

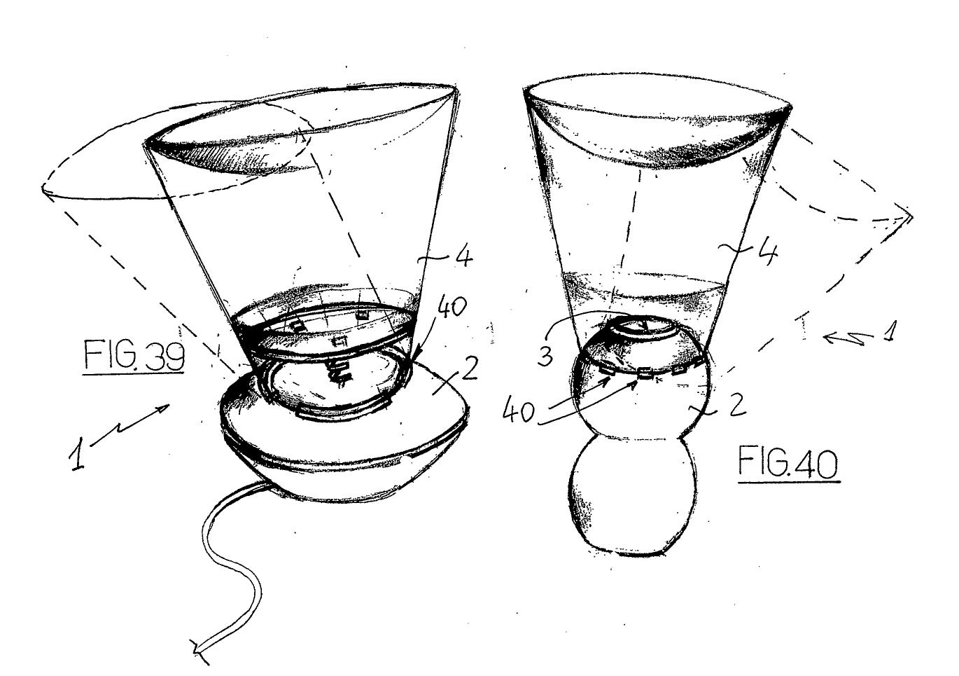

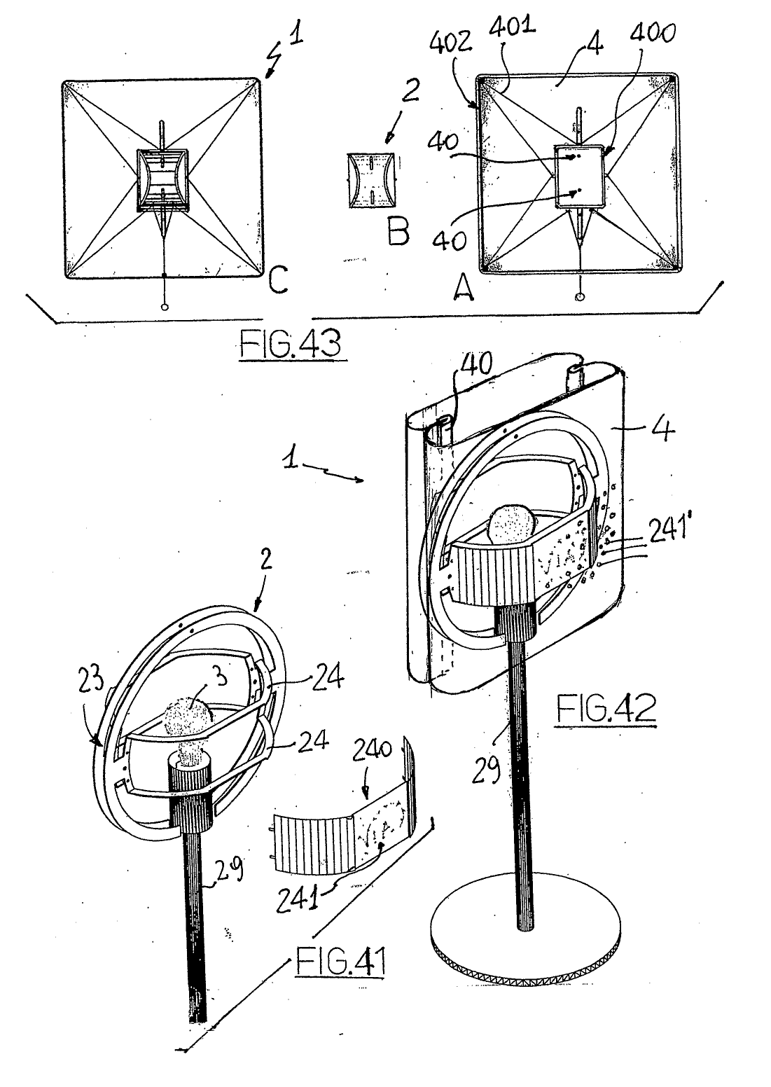

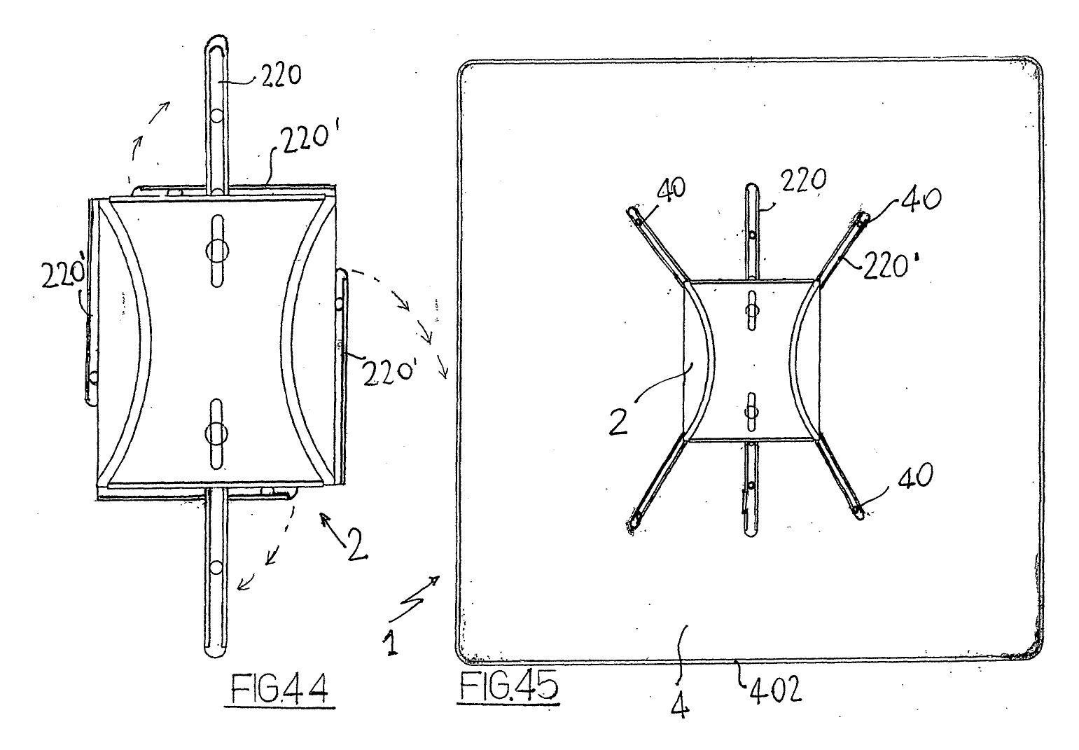

These and other advantages and characteristics of the invention will be best understood by anyone skilled in the art from a reading of the following description in conjunction with the attached drawings given as a practical exemplification of the invention, but not to be considered in a limitative sense, wherein: FIGS. 1, 2 show a possible example of realization of a structure of support for a device realized in compliance with the present invention; in FIG. 1 the structure is shown in its configuration of use in perspective sight, while in FIG. 2 an intermediate product usable for forming said structure is represented in plant view, FIGS. 3, 4, 5, 6, 7 and 8 show other possible examples of the device having a structure of support or base of analogous conformation to the one of FIG. 1; in particular, FIG. 3 is a perspective view of a structure represented, during the assembly, partially covered by a lampshade, while FIG. 4 represents the same lighting device in use; FIG. 5 represents, in a plant view, a structure before its preparation, while FIG. 6 shows in perspective view the structure in its shape during the use; FIG. 7 shows another example of the device in perspective view and its shape of use, while FIG. 8 shows in perspective view a particular of FIG. 7; FIGS. 9, 10, 11, 12, 13, 14, 15 show further possible embodiments of a device in compliance with the present invention; in particular, FIGS. 9 and 10 are, respectively, a lateral and a frontal view of a device represented in configuration of use; FIGS. 11-14 are relative to particulars in which are shown possible ways of fixing a screen to the support structure; FIG. 15 shows a different type of support structure; FIGS. 16, 17, 18, 19, 20, 21, 22, 23, 24, 25, 26, 27 show further possible embodiments of a device in compliance with the present invention in which the device comprises a reading lamp (FIGS. 16-20, 21A-E, 22) or a bracket lamp (FIGS. 21F, 23-27); FIGS. 28, 29 show two further embodiment of the invention provided with tubular elements associable to the base structure; FIGS. 30, 31 show, schematically, in perspective view, another embodiment of the invention which comprises a plate shield associated to the base structure; the FIGS. 32, 33, 34, 35, 36, 37, 38 relates to other embodiments of the invention in which the luminous source is formed by LED (FIGS. 32, 33, 34, 37, 38) or by incandescent lamps (FIGS. 35, 36); FIGS. 39, 40 show, in schematic perspective view, two embodiment of the invention constituted of reading lamps in which the screen or lampshade is adjustable; FIGS. 41, 42 show a further embodiment of the invention, represented, respectively, in an exploded perspective view without lampshade (FIG. 41) and in perspective view with lampshade (FIG. 42); FIGS. 43A, B, C show a further embodiment of the invention; FIGS. 43A and 43B are relevant to a lampshade and a support; FIG. 43C shows the two parts assembled in use; FIGS. 44, 45 are two frontal views of a further embodiment, in which the structure of support or base is provided with appendix or arms; the base is shown in FIG. 44 and the device in conditions of use in FIG. 45.

With reference to the figures of the enclosed drawings, a lighting device (1) in compliance with the invention comprises: a support or base (2) having ferromagnetic features; one or more fixing elements (40) reversibly associable to said support (2) by means of magnetic attraction; a structure (4) for supporting and/or filtering one or more luminous sources (3), said structure (4) being stably associable to the said support (2) by means of said fixing elements (40) according to different configurations.

The structure (4), can be flexible or mouldable (4), realizable using cloth, woven, plastic materials, paper material, etc. The structure (4) can have a continuous surface or it can have discontinuities; for example, it can have a net conformation or it can be provided with a plurality of holes. The luminous sources (3) can be of LED type or at low heat emission; in this way, it is possible to use for the structure (4) also materials which, in case of luminous sources at incandescence or halogen lamp, would have opportunely to be isolated. The LED can also be incorporated in the structure (4), forming an only body with the same one. In other embodiments, the luminous sources (3) can be constituted of filament lamps.

The fixing elements (40) comprise magnets and are used for maintaining the flexible/mouldable structure (4) associated to the base (2) which, as previously said, is realized in a material having ferromagnetic characteristics. The base (2) can be realized, for example, using iron, ferrous steel, etc. The base (2) can be realized also in steel or other suitable polished metal so as to provide a “mirror” effect; this characteristic can modify the effect of lighting provided by the device. Otherwise, instead of magnetic fixing elements, can be used fixing elements (40) in ferromagnetic material having characteristics suitable to be associated to a magnetic base (2). In other words, more metallic elements can be fixed to the structure of the lampshade (4) (for example by means of rivets, seam, glue, etc) so as to be attracted from the base (2) which, in this case, it is magnetic. The fixing elements (40) can be realize in a single body with the luminous sources (3); in practice, the fixing elements (40) can comprise a magnet for the fixing to the base (2) and, at the same time, a luminous source (for example of LED type with the relative supply circuit). In a possible embodiment, the luminous sources (3) can be incorporated in the flexible structure (4), so constituting a single body with the same. The luminous sources (3) can also be reversibly associable to the flexible structure (4) in different ways like, as an example, by means of a detachable glue, by means of a known fixing means type like Velcro, etc.

A device (1) according to the present invention allows an extreme variability of the possible configurations. In fact, thanks to the magnetic association, the flexible or mouldable structure (4) can be maintained more or less tightened relating to the base (2) on which it is fixed. In this way it is possible to execute a moulding of the structure (4) which allows to obtain a substantially infinite number of different configurations. Consequently, the luminous emissions and the formed effects of light and shadow will be very differentiable.

With reference to FIGS. 1-8 and 41-42, the base (2) can be realized using a metallic sheet. The relative method of realization comprises: marking a series of lines on a metallic sheet, executing complete and incomplete cuts, so as to define portions which can be subsequently folded in order to form an hollow body usable, for example, to contain the luminous sources (3) of the device (1).

In FIGS. 1-8, the cutting lines have been marked with (21), with (22) a central hole and with (20) the folding lines. The intermediate product having a flat development, as the example shown in FIG. 1, is folded at the center, in correspondence of the two folding lines (20) disposed in proximity of the central hole (22). The cutting lines (21) subdivide the sheet of the structure of base (2) in more portions. The peripheral portions (25), disposed coupled, define a rail or guide (23) which extends perimetrically around the structure (2), while the inner portions (24) form strips which delimit the inside of the base structure (2). In order to improve the stability of the structure so formed, there are holes (26) arranged symmetrically so as to be suitably crossed by fixing means like screws and similar. The hole (22) can be fit on the top of rod (29) of the device (1), so as to fix the base (2) to the rod (29) in correspondence of the lamp-holder (30). In this case, the flexible structure or lampshade (4) has a substantially cylindrical conformation and it is formed by two semi-parts joined between themselves so as to form a double edge (41) which remains on the inner side of the structure (4). The double edge is provided with a series of magnets disposed in succession along the same edge, or with a magnet having a linear extension of substantially equal length to the same and overlapped to the same edge. In the drawings, numerical reference (40) is used for representing both the solutions. As shown also in FIG. 3, the lampshade (4) is applied from above on the base structure (2), inserting the edges (41) inside of the guide (23). The possibility of movement of magnets (40) along the guide (23), together with the flexibility of material the lampshade (4) concurs “to deform” the same lampshade which can assume, stably but reversibly, a substantially infinite series of different configurations. In FIG. 6 the directions of the possible movement are schematically indicated with arrows.

In FIG. 7 is represented an embodiment of the invention in the which the structure of base (2) is similar to the examples of FIGS. 5 and 6. In this case, the base structure (2) is suspended through wires or ropes (27) so as to define a ceiling lamp. Moreover, the lampshade (4) is formed of two elements (44) couples each other. Each element (44), as visible in FIG. 8, is formed of two elements having a circular development (49), extending for more than 180° and connected in correspondence of two central hinges (42). In configuration of use, the hinges (42) are opened and the fixing of the lampshade to the base (2) is guaranteed also from by presence of horizontal tie-rods (48) which connect the perimetrically opposite portions (47) of the elements (44).

Also the example of FIGS. 41-42 relates to a device (1) provided with a base (2) realizable by a metallic sheet. The base (2) is fixed to a rod (29) having a support base, represented only partially in FIG. 41. In this example, as in the examples of FIGS. 1-8, the lampshade (4) is fixable to the structure (2) by means of one or more magnets (40) which are inserted in the guide or rail (23) of the base (2). Advantageously, the device (1) of FIGS. 41-42 is provided with an additional screen (240) applicable to the base (2) in correspondence of the luminous source (3). The additional screen (240), which can be realized also in metal, has a double function: it provides an element of protection for the lamp (3), isolating it from the lampshade (4) and, at the same time, thanks to a series of holes (241) disposed according to a design or a preset word, provides a remarkable aesthetic effect thanks to the projection of the design (241′) on the lampshade(4) when the lamp is turned on. In other words, it is obtained the functions of projection and of protection in a very limited thickness.

In FIGS. 9-15, the lighting device (1) is a reading lamp type. In this case, the base (2) is supported by a rod (29) and comprises two coplanar plates (2), each of them is formed by two circles partially overlapped. The lampshade (40) is fixed to the base (2) by means of four magnets (40) which allow the positioning in different configurations. In FIG. 15, the base 5 has oval shape. In the drawings the arrows have been used in order to indicate the possibilities of movement of the lampshade (4) regarding the base (2).

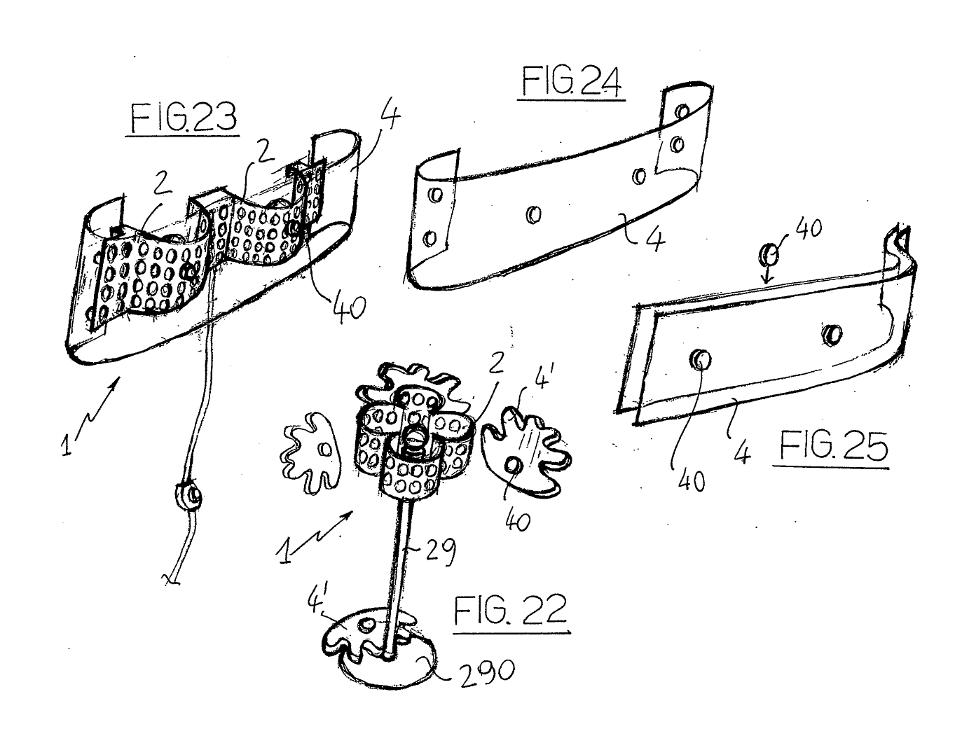

In FIGS. 16-31 the base (2) has a holed reticular or laminar structure. In particular, in FIGS. 16-20, the device (1) is constituted of a reading lamp in which the base structure (2) has a circular plant and is provided with a plurality of holes. The lampshade (4), in this case, is provided with four magnets (40) which allow the fixing to the base (2). In FIG. 20 it is shown, in a plant view, the possible movement of the lampshade (4) around the base (2). In FIG. 21A a base structure (2) is disposed on a rod (29) of a lamp (1), visible in FIG. 21B. The base (2) has a circular plant and a reticular conformation. In this case, a plurality of elements (4′) are applied on the base structure (2), said elements (4′) can shield the light produced from the source (3) and can introduce a particular aesthetic effect and an additional function. In fact, they can be formed as particular ornamental shape or a design, like in the example; moreover, the elements (4′) can be provided with an additional body (45) that allows the positioning of notes sheets (46). Practically, the elements (4′) are associated to the base (2) thanks to the magnets (40), which can be different from the elements (4′), like in the example of FIG. 21C, or realized in a single body with the same elements (4′), like in the examples of FIGS. 21D-H. In FIG. 21F, the base structure (2) is usable in order to realize a bracket lamp; it is of reticular type and has a curvilinear profile. The base (2) is moreover provided with folded portions (43) which allow the fixing of the device to the wall. The example of FIG. 22 is relative to a reading lamp (1) in which the base (2) has a four-lobes plant and it is provided with holes. In this example, the elements (4′), which are similar to those of the example of FIGS. 21A-F, have the profiles conformed so as to be complementarily combinable. In particular, the elements (4′) can be supported on the base (290) of the lamp so that the profiles are joined in order to completely cover the surface of foot (290). In other words, the covering of foot (290) of the lamp is obtained (1) using the elements (4′) and relative fixing magnets (40). In FIGS. 24-25 the device (1) is a bracket lamp in which the lampshade (4) can be at one (FIG. 24) or two layers (FIG. 25), held together by the magnets (40).

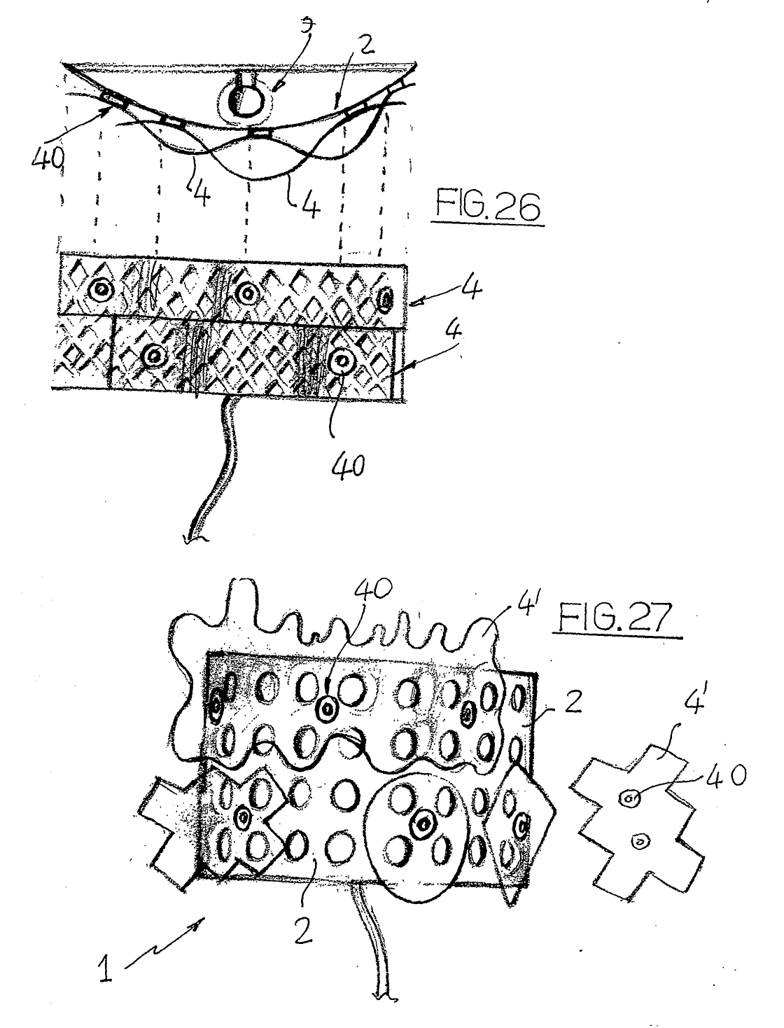

In FIG. 26 (where the device is represented in plant and also frontally), is shown a bracket lamp (1) in which the base (2) has a substantially circular profile and is provided with meshes. On the base (2) are fixed, by the magnets (40), two lampshades (4) that have a curvilinear profile. In this way, the height development of the base (2) is subdivided in two portions, with different bending: this feature determines a particular diffusion of the light, with effects of chiaroscuro of remarkable relief.

The bracket lamp (1) of FIG. 27 has a substantially circular base (2) and is provided with holes distributed on all its surface. On the base (2) are fixed, by the magnets (40), many shielding elements (4′) differently conformed. The elements (4′) can be permeable to the light with different colorations, so as to provided, also in this case, particular chromatic effects.

In the examples of FIGS. 28, 29, the shielding structures are constituted of tubular elements (4″) which can be preferably realized in transparent material, also coloured. The elements (4″) can be associated to the base (2) since are provided, at the ends, with the magnets (40). The magnets (40) have a ring-like conformation so as to be suitably fixable to the base (2) in correspondence of a hole, being crossed by the light through the same element (4″). In the example of FIG. 28 the luminous source (3) is a light incandescence bulb (3), while in the example of FIG. 29 the luminous source is provided with LED (3).

In the example of FIGS. 30, 31 the screen (4) is constituted of a portion of flat material (like cloth, fabric, paper, etc) having a substantially circular development, provided with a relatively rigid frame (49), realizable, as an example, by metal or plastic material. In this case, the connection between the screen (4) and the base (2) are provided, with the magnets (40) which are attracted by the base (2), with the interposition of the screen (4) between the base (2) and the magnets (40).

In FIGS. 32-40 are schematically represented by discontinuous line the positions which can have the screen (4) (which is bound to the base (2) by the magnets (40)) and the positions of same magnets (40).

In FIGS. 32, 33, 34 the luminous sources are of LED type, while in the example shown in FIGS. 35, 36 the luminous source (3) is of the incandescence type.

In the case of the LED, these latter can be incorporated in the woven of the lampshade (4), therefore like the magnets (40).

The base (2) can be realized in reflecting material like, as an example, in polished metal with ferromagnetic characteristics; in this way, will be obtained a mirror which will further increase the lighting effects of the device (1).

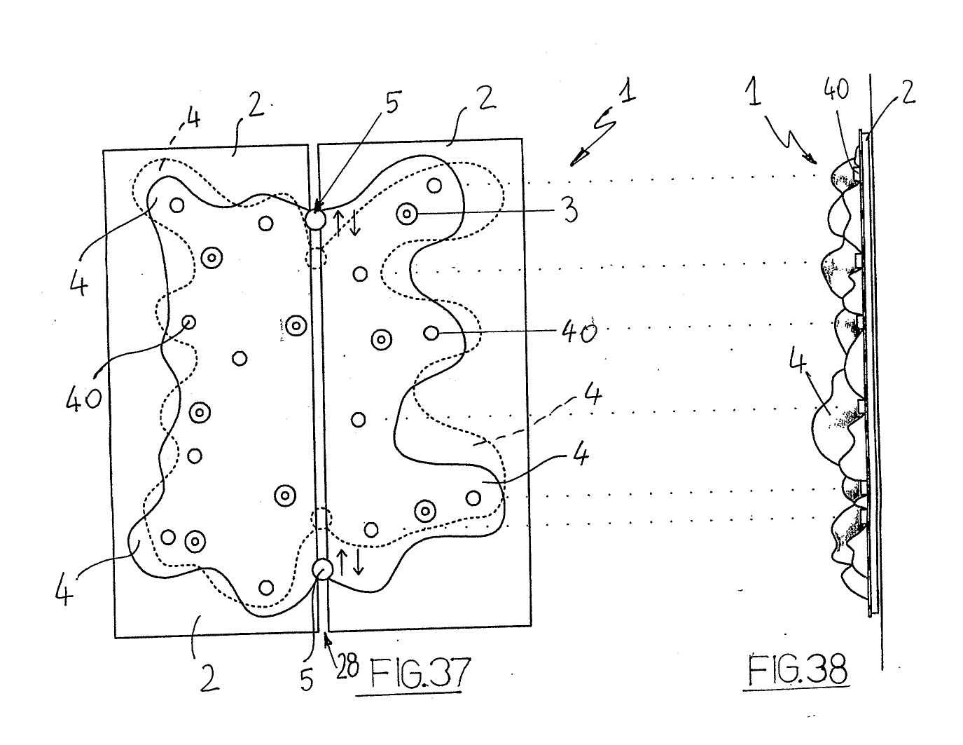

In the example of FIGS. 37, 38, the base (2) is subdivided in two parts, forming a central guide or rail (28) in which are movable two sliders (5) connected to the screen (4); in this way it is possible to modify the conformation offered by the device (1).

In FIGS. 39, 40 the devices (1) are reading lamps, with a base (2) on which is disposed a lampshade (4). The lampshade (4) is provided, in correspondence of its inferior portion, with magnets (40) which allow the stable but variable association of the same lampshade (4) with said base (2). The lampshade (4) is shaped as a frustum of cone turned upside down (with the greater base up) and it can be rotate in respect to the base (2), as indicated by the discontinue line in the drawings, since magnets (40) is disposed along the circumference of the smaller base of the lampshade, which is in contact with the base (2) (in metal having ferromagnetic property) of the device (1).

In FIGS. 43A-C is shown a lampshade 4 provided with an external frame 402, to which is fixed fabric (or other material) which forms the screen, and with an inner frame 400, internally hollow and having a perimeter substantially correspondent to the perimeter of the base (2). The two frames are connected by one or more tie-rods 401. On the woven of the lampshade the magnets (40) are fixed. In this embodiment, the base (2) is fixed to a wall and the lampshade (4) is fixed to the base (2) thanks to the joint of the inner frame (400) on the base (2). In phase of assemblage, the fixing is very easy.

In the example of FIGS. 44, 45 the base (2) are provided of appendix or arms (220) and (220′). In particular, the arms (220′) are hinged in correspondence of their proximal in order to be “open” when the device (1) is in use configuration. In this way, it is obtained a contained encumbrance in phase of storage and transport and, in use configuration, are increased the points of association between base (2) and lampshade (4), and also the area of the association zone is increased, concurring therefore to apply to the base (2) also lampshades of dimensions relatively elevated.

1-23. (canceled)

24. A lighting device, comprising:
a support having ferromagnetic features;
one or more fixing elements reversibly associable to the support by means of magnetic attraction; and
a structure for at least one of supporting and shielding one or more luminous sources, wherein the structure is stably associable to the support by means of the fixing elements, fixed to the support according to different configurations.

25. The device according to claim 24, wherein the one or more fixing elements are comprised of magnets.

26. The device according to claim 24, wherein the structure for at least one of supporting and shielding of the one or more luminous sources is one of flexible and mouldable.

27. The device according to claim 24, wherein the structure for at least one of supporting and shielding is constructed from one of fabric and cloth.

28. The device according to claim 24, wherein the structure for at least one of supporting and shielding is constructed from plastic material.

29. The device according to claim 24, wherein the structure for at least one of supporting and shielding is shaped substantially as a net.

30. The device according to claim 24, wherein the structure for at least one of supporting and shielding has a continuous development.

31. The device according to claim 24, wherein the support is shaped substantially as a net.

32. The device according to claim 24, wherein the support has a continuous development.

33. The device according to claim 24, wherein the one or more luminous sources are supported from the structure and are of LED type.

34. The device according to claim 24, wherein the one or more luminous sources are incorporated in the structure, thereby constituting a single body with the same.

35. The device according to claim 24, wherein the one or more luminous sources are reversibly associable to the structure.

36. The device according to claim 24, wherein the one or more luminous sources are associated to the one or more fixing elements.

37. The device according to claim 24, wherein the structure is arranged interposed between the support and the one or more fixing elements.

38. The device according to claim 24, wherein the support is formed from a metallic sheet, provided with a series of lines formed by complete and incomplete cuts, defining foldable portions apt to delimit a hollow body suitable to contain the luminous sources of the device.

39. The device according to claim 38, wherein the series of lines define a plurality of peripheral portions which, when the support is assembled, define a rail or guide which extends perimetrically around the base, the guide being suitable to receive the one or more fixing elements.

40. The device according to claim 24, wherein the structure for at least one of supporting and shielding is formed by tubular elements, realized in at least one of transparent and colored material, associable to the support by magnets provided at the ends thereof.

41. The device according to claim 24, wherein the structure for at least one of supporting and shielding is constituted of a plurality of elements associable by means of magnets to the support in order to shield light produced from the one or more luminous source.

42. The device according to claim 41, wherein the tubular elements are provided with an additional body which allows the lodging of notes sheets.

43. The device according to claim 41, wherein the tubular elements are shaped in order to be complementarily associable with each other.

44. The device according to claim 38, further comprising an additional screen having at least one of a design and a word formed thereon by means of a plurality of holes, the additional screen being associable to the support in correspondence of one or more luminous source so as to project the at least one of design and word on the structure.

45. The device according to claim 24, wherein the support is magnetized.

46. The device according to claim 24, wherein the support is provided with one or more arms having a variable positioning, the arms having a contained encumbrance in phase of storage and transport and a greater encumbrance in use configuration.
